(19) United States
(12) Patent Application Publication
(10) Pub. No.: US 2025/0155672 A1
(43) Pub. Date: May 15, 2025

(54) OPTICAL MIRROR, SCANNING OPTICAL DEVICE, IMAGE FORMING DEVICE, AND MANUFACTURING METHOD FOR OPTICAL MIRROR

(71) Applicant: Konica Minolta, Inc., Tokyo (JP)

(72) Inventors: Akira TANIYAMA, Tokyo (JP); Ryo HASEGAWA, Tokyo (JP); Takahiro MATSUO, Tokyo (JP); Yoshihiro INAGAKI, Tokyo (JP); Ema MOCHIZUKI, Tokyo (JP)

(21) Appl. No.: 18/941,007

(22) Filed: Nov. 8, 2024

(30) Foreign Application Priority Data
Nov. 9, 2023 (JP) 2023-191787

(51) Int. Cl. G02B 7/182; G02B 17/00; G02B 26/12; G03G 15/01; G03G 15/04

(52) U.S. Cl. CPC G02B 7/182; G02B 17/006; G02B 26/125; G03G 15/04072; G03G 15/011

(57) ABSTRACT

An optical mirror with an elongated shape, including: a mirror including a substrate and a reflective surface formed on one end surface in a thickness direction of the substrate; a reinforcing member with an elongated shape bonded to a surface of the mirror opposite to the reflective surface; an adhesive layer disposed between the mirror and the reinforcing member, wherein the adhesive layer partially covers an adhesive surface between the mirror and the reinforcing member, and wherein on a central axis extending in a longitudinal direction of the adhesive surface, a sum of a maximum length of the adhesive layer in the longitudinal direction is 40% or more of a length of the adhesive surface in the longitudinal direction.

### CROSS REFERENCE TO RELATED APPLICATIONS

The present invention claims priority under 35 U.S.C. § 119 to Japanese Patent Application No. 2023-191787 filed on Nov. 9, 2024, the entire content of which is incorporated herein by reference.

### BACKGROUND

### Technological Field

The present invention relates to an optical mirror, a scanning optical device, an image forming device, and a manufacturing method for an optical mirror.

### Description of Related Art

In the related art, an image forming device of an electrophotographic method using toner includes a scanning optical device for exposing a surface of a uniformly charged photoreceptor to light to form an electrostatic latent image. The scanning optical device includes a light source and a long optical mirror for reflecting light emitted from the light source toward the surface of the photosensitive member.

In the image forming device, vibration occurs during operation. When the frequency of the vibration caused by the operation of the image forming device coincides with the resonance frequency of the optical mirror, the optical mirror resonates. When the optical mirror resonates, a change in an exposure position with respect to the photoreceptor and density unevenness of an image accompanying the change occur. As an optical mirror for suppressing the resonance of the optical mirror, there is known an optical mirror in which a reinforcing member is bonded to a surface of a mirror main body opposite to a reflective surface.

For example, PTL 1 (JP H08-106129 A) discloses an optical mirror in which a flatness reinforcing member having a flatness of 100 mR or more is closely fixed to a surface opposite to a reflective surface of the optical mirror with an adhesive or the like, and an optical mirror scanning device including the optical mirror. According to PTL 1, it is described that the above-described optical mirror can provide a vibration damping effect without degrading the planarity of the optical mirror.

PTL 2 (JP H06-175006 A) discloses a reflecting mirror for optical scanning in which a glass plate is bonded to the rear surface of a plastic reflecting mirror with an adhesive. According to PTL 2, the reflector is less likely to warp and is highly accurate and easy to manufacture.

However, when the mirror body and the reinforcing member are adhered to each other with an adhesive, the resonance frequency of the optical mirror tends to greatly fluctuate due to slight fluctuation in the length of the adhesive layer in the longitudinal direction of the adhesive surface, depending on the manner of adhesion. In addition, depending on the way of bonding, the resonance frequency of the optical mirror tends to coincide with the frequency of vibration caused by the operation of the image forming device, and the optical mirror tends to resonate.

According to the studies of the present inventors, the above-described variation in the resonance frequency can be suppressed by applying an adhesive to the entire surface of the adhesive surface between the mirror body and the reinforcing member. In addition, since the resonance frequency of the optical mirror is increased by the full-surface adhesion between the mirror body and the reinforcing member, it is possible to make it difficult for the resonance frequency of the optical mirror to coincide with the frequency of the vibration due to the operation of the image forming device.

However, if an adhesive is applied to the entire adhesive surfaces of the mirror body and the reinforcing member for bonding, the adhesive overflows when these members are pressed during bonding, which causes a burden on an operator due to occurrence of work such as cleaning.

### SUMMARY

An object of the present invention is to provide an optical mirror capable of suppressing a fluctuation in resonance frequency due to a fluctuation in length of an adhesive layer and occurrence of resonance in an image forming device, and hardly imposing a burden on an operator in production, a scanning optical device including the optical mirror, an image forming device, and a manufacturing method for an optical mirror.

To achieve at least one of the abovementioned objects, an optical mirror with an elongated shape, includes: a mirror including a substrate and a reflective surface formed on one end surface in a thickness direction of the substrate; a reinforcing member with an elongated shape bonded to a surface of the mirror opposite to the reflective surface; an adhesive layer disposed between the mirror and the reinforcing member, wherein the adhesive layer partially covers an adhesive surface between the mirror and the reinforcing member, and wherein in a longitudinal direction of the adhesive surface, a sum of a maximum length of the adhesive layer in the longitudinal direction is 40% or more of a length of the adhesive surface in the longitudinal direction.

### BRIEF DESCRIPTION OF DRAWINGS

The advantageous and features provided by one or more embodiments of the invention will become more fully understood from the detailed description given hereinbelow and the appended drawings which are given by way of illustration only, and thus are not intended as a definition of the limits of the present invention:

FIG. 1 is a schematic cross-sectional view illustrating a configuration of an optical mirror according to a first embodiment of the present invention,

FIG. 2 is a plan view of an adhesive surface and an adhesive layer of the and mirrors and the reinforcing member in the first embodiment when viewed from a reflective surface side,

FIG. 3 is a flowchart illustrating a manufacturing method for an optical mirror,

FIG. 4 is a schematic diagram illustrating a state when the reinforcing member is pressed to be adhered to the mirror,

FIG. 5 is a schematic cross-sectional view illustrating an example of the configuration of the image forming device,

FIG. 6 is an external perspective view illustrating a configuration of a scanning optical device,

FIG. 7 is a plan view of an appearance of the scanning optical device from above in a vertical direction,

FIG. 8 is a schematic cross-sectional view of the scanning optical device taken along a horizontal plane passing below the upper surface of the optical deflector in the vertical direction,

FIG. 9 is a schematic cross-sectional view of the scanning optical device taken along the line D-D in FIG. 8,

FIG. 10 is a schematic diagram illustrating an example of an aspect of an optical mirror included in the scanning optical device,

FIG. 11 is a plan view of the optical mirror to which the support member is attached when viewed from the side of the reflective surface,

FIG. 12 is a plan view of an adhesive surface and an adhesive layer between the mirror and the reinforcing member of the optical mirror according to a second embodiment when viewed from the side of the reflective surface,

FIG. 13 is a graph showing the relationship between the lengths of the adhesive layers of the optical mirrors 1 to 8 and the resonance frequencies of the primary bending vibration in the example,

FIG. 14 is a graph illustrating a relationship between the length of the adhesive layer of each of the optical mirrors 1 to 8 and the resonance frequency of the secondary bending vibration in an example; and

FIG. 15 is a plan view of the adhesive surface and the adhesive layer between the mirror and the reinforcing member of the optical mirror 11 according to the example as viewed from the reflective surface side.

### DETAILED DESCRIPTION OF EMBODIMENTS

Hereinafter, one or more embodiments of the present invention will be described with reference to the drawings. However, the scope of the invention is not limited to the disclosed embodiments.

### 1 First Embodiment

### 1-1. Optical Mirror

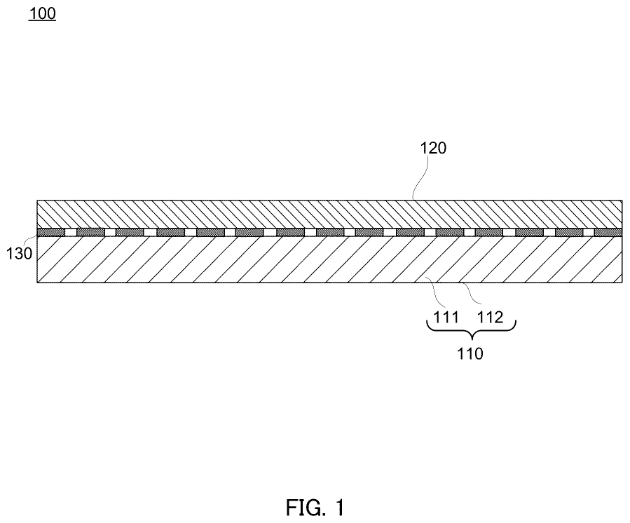

FIG. 1 is a schematic cross-sectional view illustrating a configuration of an optical mirror 100 according to a first embodiment. As illustrated in FIG. 1, the optical mirror 100 is an optical mirror with an elongated shape, and includes a mirror 110, a reinforcing member 120 bonded to a surface of the mirror 110 opposite to a reflective surface 112, and an adhesive layer 130 disposed between the mirror 110 and the reinforcing member 120. Note that in the present specification, the “elongated shape” refers to a shape having an aspect ratio (length in longitudinal direction/length in short direction) of 7.5 or more.

### 1-1-1. Mirror

The mirror 110 includes a substrate 111 and the reflective surface 112 formed on one thickness-direction end surface of the substrate 111. The mirror 110 has an elongated shape.

The material of the substrate 111 is not particularly limited, but is, for example, glass, and aluminum, or metal such as SPCC. Of these, glass is preferable as the material of the substrate 111. Furthermore, the size of the substrate 111 can be adjusted as appropriate in accordance with the design of the optical the mirror 110.

The reflective surface 112 has a function of reflecting light. Examples of materials for the reflective surface 112 include aluminum, chrome, titanium, etc. Of these, the material of the reflective surface 112 is preferably aluminum. The reflective surface 112 may be formed on the entirety of the one end surface of the substrate 111 or may be formed on part of the one end surface but is preferably formed on the entirety of the one end surface.

The reflective surface 112 can be formed by performing a method such as vapor deposition and sputtering on the one end face of the substrate 111 using the above-described material.

### 1-1-2. Reinforcing Member

The reinforcing member 120 is bonded to the surface of the mirror 110 on the side opposite to the reflective surface 112 and can increase the rigidity of the mirror 110.

The shape of the reinforcing member 120 is not particularly limited, but is preferably an elongated shape. At this time, the length and the width of the reinforcing member 120 in the longitudinal direction are preferably the same as the length and the width of the mirror 110 in the longitudinal direction. Accordingly, when the mirror 110 (particularly, the substrate 111) and the reinforcing member 120 are manufactured, a processing jig for processing a base material can be shared, and a case for conveyance can be formed in a similar shape. Therefore, it is possible to reduce the cost for manufacturing these members.

The material of the reinforcing member 120 is not particularly limited, but is, for example, a glass, SPCC. Among these, from the viewpoint of further increasing the rigidity of the mirror 110, the material of the reinforcing member 120 is preferably glass.

The material of the reinforcing member 120 is preferably the same type as the material of the substrate 111 of the mirror 110. As a result, since a difference in the degree of thermal expansion between the two is less likely to occur, deformation of the optical mirror 100 due to heat in the image forming device can be made less likely to occur.

When the material of the reinforcing member 120 is glass, the thickness of the reinforcing member 120 is preferably smaller than the thickness of the mirror 110, and more preferably 50% or more and 60% or less of the thickness of the mirror 110. Thus, the flatness of the reinforcing member 120 is less likely to be impaired, and the reinforcing member 120 and the mirror 110 are less likely to be displaced from each other when they are bonded together. Furthermore, when the thickness of the glass the reinforcing member 120 is smaller than the thickness of the mirror 110, the surface of the reinforcing member 120 is preferably unpolished. Since the thickness of the reinforcing member 120 is smaller than the thickness of the mirror 110, the mirror 110 is less likely to be deformed than the reinforcing member 120, and therefore, even if the surface of the reinforcing member 120 is unpolished, the flatness of the optical mirror 100 as a whole is less likely to be reduced. In addition, the use of the unpolished glass the reinforcing member 120 can reduce the cost for producing the optical mirror 100.

### 1-1-3. Adhesive Layer

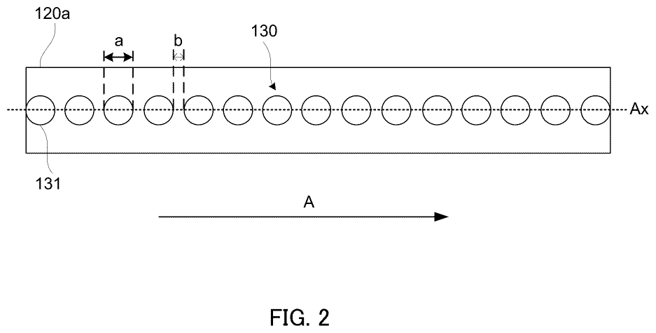

The adhesive layer 130 is disposed between the mirror 110 and the reinforcing member 120. FIG. 2 is a plan view of an adhesive surface 120a between the mirror 110 and the reinforcing member 120 and the adhesive layer 130 as viewed from the reflective surface 112 side. The adhesive layer 130 partially covers the adhesive surface 120a between the mirror 110 and the reinforcing member 120, and in the longitudinal direction of the adhesive surface 120a (the direction of the arrow A in FIG. 2), the total of the maximum length of the adhesive layer 130 in the longitudinal direction (the lengths of the arrows a in FIG. 2) is or more than 40% of the lengths of the adhesive surface 120a in the longitudinal direction. Note that in the present specification, the “adhesive surface 120a” refers to one of the surfaces of the reinforcing member 120 with which the mirror 110 and the reinforcing member 120 are in contact. Furthermore, a “longitudinal direction” refers to a direction in which a long side of the adhesive surface 120a extends.

According to the study by the present inventors, it has been found that when the total of the length of the adhesive layer 130 in the longitudinal direction of the adhesive surface 120a is short, the resonance frequencies of the optical mirror are likely to greatly fluctuate due to a slight fluctuation in the total of the length of the adhesive layer 130. The slight variation in the length can be caused by, for example, a difference in the degree of pressing of the reinforcing member 120 during bonding. It has also been found that when the length is short, the resonance frequency of the optical mirror is likely to match the frequency of vibration due to the operation of the image forming device.

Therefore, the present inventors have found that by setting the sum of the maximum length of the adhesive layer in the longitudinal direction of the adhesive surface 120a to 40% or more of the length of the adhesive surface 120a in the longitudinal direction, the resonance frequencies of the optical mirror can be made less likely to fluctuate even if the length fluctuates. The present inventors have also found that setting the total of the length to 40% or more of the longitudinal length of the adhesive surface 120a can set the resonance frequency of the optical mirror 100 close to the value that is obtained when the mirror 110 and the reinforcing member 120 are bonded to each other with the adhesive applied to the entire adhesive surface 120a (i.e., when the adhesive layer 130 covers the entire adhesive surface 120a). Thus, resonance of the optical mirror 100 due to vibration of the image forming device can be suppressed.

Next, in the optical mirror 100 according to the present embodiment, the adhesive layer 130 partially covers the adhesive surface 120a, and therefore the adhesive is unlikely to overflow from between the mirror 110 and the reinforcing member 120. Thus, it is possible to reduce a burden on the operator at the time of manufacturing the optical mirror 100.

In this specification, the terms “resonance frequency” and “resonance” refer to the resonance frequency and resonance of the primary bending vibration of the optical mirror 100. Since the primary bending vibration has a large amplitude, periodic density unevenness in an image is likely to be visually recognized. Therefore, in terms of operating the image forming device, it is important to suppress the resonance of the primary bending vibration and the fluctuation of the resonance frequency.

The total of the maximum length of the adhesive layer 130 in the longitudinal direction in the longitudinal direction of the adhesive surface 120a is 40% or more, or preferably 60% or more, of the length of the adhesive surface 120a in the longitudinal direction. When the total of the maximum length is 60% or more, it is possible to suppress a fluctuation in the resonance frequency of the secondary bending vibration of the optical mirror 100 due to a fluctuation in the length of the adhesive layer 130. When the total of the maximum length is 60% or more, the resonance frequencies of the secondary bending vibration of the optical mirror 100 can be set close to the value that is obtained when the mirror 110 and the reinforcing member 120 are bonded to each other by applying an adhesive to the entire adhesive surface 120a between the mirror 101 and the reinforcing member 102. When the adhesive layer 130 covers the entire adhesive surface 120a, the resonance of the secondary bending vibration is less likely to occur in the image forming device. Therefore, with the total of the maximum length of 60% or more, the resonance of the secondary bending vibration of the optical mirror 100 due to vibration of the image forming device can be suppressed. The upper limit of the total of the length is, for example, 100% of the longitudinal length of the adhesive surface 120a.

The adhesive layer 130 may partially cover the adhesive surface 120a, but the coverage of the adhesive layer 130 is preferably 30% or more, and more preferably 50% or more of the adhesive surface 120a.

In the present embodiment, the adhesive layer 130 is composed of a plurality of adhesive members 131, and the plurality of adhesive members 131 are all composed of an adhesive. The adhesives constituting the plurality of adhesive members 131 may be of the same type or different types.

The shape of the plurality of adhesive members 131 in plan view is not particularly limited but is, for example, a circular shape or an elliptical shape. Of these, a circular shape is desirable. When the shape is set to a circular shape, it is not necessary to move the reinforcing member in the in-plane direction of the substrate when an adhesive applied to the substrate is pressed by the reinforcing member in a step (step S20) of attaching the reinforcing member and the mirror to each other, which will be described later, and hence the bonding operation and the production of a bonding jig are facilitated. In the example of FIG. 2, the plan view shape is a circular shape. In addition, it is preferable that all of the plurality of adhesive members 131 are disposed on a central axis Ax extending in the longitudinal direction of the adhesive surface 120a.

The intervals between the plurality of adhesive members 131 may be equal intervals or unequal intervals, but are preferably equal intervals. If the intervals between the plurality of adhesive members 131 are equal intervals, the resonance frequencies of the optical mirror 100 can be made closer to the value that is obtained when the entire surface of the adhesive surface 120a between the mirror 110 and the reinforcing member 120 is covered by the adhesive layer 130.

The thicknesses of the adhesive layers 130 (the plurality of adhesive members 131 in the present embodiment) are not particularly limited, but are preferably greater than or equal to 0 mm and less than or equal to 0.05 mm. Thus, the adhesion strength between the mirror 110 and the reinforcing member 120 can be further increased, and a variation in resonance frequency due to deformation of the adhesive layer 130 or a variation in thickness thereof can be suppressed.

Although the type of the adhesive constituting the adhesive layer 130 (the plurality of adhesive members 131 in the present embodiment) is not particularly limited, the adhesive layer 130 (the plurality of adhesive members 131) is preferably an adhesive layer (adhesive member) formed by curing an ultraviolet curable adhesive. The ultraviolet curable adhesive is often used for bonding members other than the optical mirror 100 to each other when the scanning optical device in the image forming device is assembled. In addition, the ultraviolet curable adhesive is easily cured in a short time as compared with other adhesives such as a thermosetting adhesive. Therefore, use of the ultraviolet curable adhesive also for the adhesion between the mirror 110 and the reinforcing member 120 can increase the efficiency of manufacturing the scanning optical device.

### 1-2. Manufacturing Method for Optical Mirror

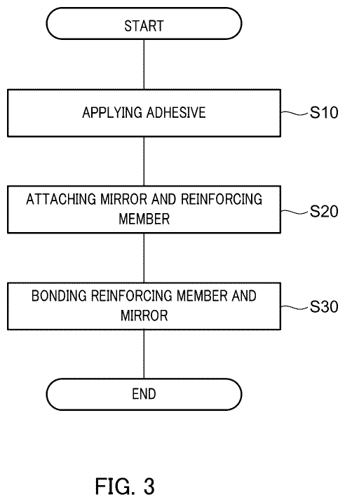

FIG. 3 is a flowchart illustrating a manufacturing method for the optical mirror 100 according to the present embodiment. As illustrated in FIG. 3, the manufacturing method includes a step of applying an adhesive to a plurality of locations at intervals on a surface of a mirror including a reflective surface on a side opposite to the reflective surface (step S10), a step of attaching a reinforcing member to the surface of the mirror to which the adhesive is applied (step S20), and a step of bonding the mirror and the reinforcing member (step S30).

### 1-2-1. Step of Applying Adhesive (Step S10)

In this step, an adhesive is applied to the mirror 110 including the reflective surface 112 on the surface opposite to the reflective surface 112 at a plurality of places at intervals. The type of the adhesive is not particularly limited but is preferably an ultraviolet curable adhesive.

The method of applying the adhesive is not particularly limited, and is, for example, a method using a spray gun, a dispenser, or the like. The amount of adhesive applied can be determined according to the following procedure. First, the relationship between the adhesive application amount and the adhesive layer area is determined by an experiment. Then, assuming that the shape of the adhesive to be applied in plan view is a circular shape, the relationship between the amount of adhesive applied and the maximum length of the adhesive layer in the longitudinal direction is obtained from the determined relationship. Based on the obtained relationship, it is possible to obtain the application amount of the adhesive at which the total of the maximum length of the adhesive layers is 40% of the longitudinal length of the adhesive surface 120a.

At this time, it is preferable to determine the application amount of the adhesive in consideration of a variation in the application amount of the adhesive of an apparatus that applies the adhesive. For example, In the case where the adhesive is applied using a dispenser, if the variation in the discharge amount of the dispenser is ±13%, the variation in the length of the adhesive layer 130 in the longitudinal direction is empirically obtained as approximately ±6.3%. For this reason, a target value (set value) of the total of the maximum length of the adhesive layer 130 in the longitudinal direction is set to 46.3% of the length of the adhesive surface 120a in the longitudinal direction, and the application amount of the adhesive is set to the amount corresponding to the target value. Thus, the total of the length of the adhesive layer 130 in the longitudinal direction can be easily adjusted to 40% or more of the length of the adhesive surface 120a in the longitudinal direction. Further, by setting the application interval of the adhesive to be larger than the spread length (empirically obtained) of the adhesive layer 130 in the set adhesive application amount, it is possible to suppress coalescence of the applied adhesive when the mirror 110 and the reinforcing member 120 are bonded to each other by the adhesive. As a result, the adhesive layer 130 can be adjusted so as to be constituted by the plurality of adhesive members 131.

The application of the adhesive in this step may be line application, surface application, or dot application. Of these, dot application is preferable. Dot application of the adhesive eliminates the need for control over the discharge speed of the adhesive and the moving speed of the discharge device, and the optical mirror 100 can be manufactured by controlling only the discharge amount and. Therefore, the control related to the application of the adhesive is simple, and the management and calibration of the device for applying the adhesive can also be simplified. Note that “dot application” refers to a coating method in which an adhesive is applied without moving the ejection device in an in-plane direction of the substrate, and the adhesive is not spread by a method other than crushing the adhesive with a reinforcing member.

In this step, the adhesive may be applied at equal intervals or at unequal intervals, but is preferably applied at equal intervals. Thus, the optical mirror 100 in which the plurality of adhesive members 131 are arranged at equal intervals can be easily manufactured.

Note that the mirror 110 and the reinforcing member 120 used in this step are the same as those described for the optical mirror 100, and therefore, detailed description is omitted.

### 1-2-2. Step of Attaching Reinforcing Member and Mirror (Step S20)

In this step, the reinforcing member 120 is attached to the surface of the mirror 110 to which the adhesive is applied. A method of attaching the reinforcing member 120 and the mirror 110 to each other is not particularly limited. The reinforcing member 120 and the mirror 110 may be manually attached to each other or may be attached to each other by using a tool or the like.

### 1-2-3. Step of Bonding Reinforcing Member and Mirror (Step S30)

In this step, the mirror 110 and the reinforcing member 120 are bonded.

A method of bonding the mirror 110 and the reinforcing member 120 is, for example, a method of pressing and bonding the reinforcing member 120. When the adhesive is an ultraviolet curable adhesive, the mirror 110 and the reinforcing member 120 can be bonded together by irradiating the adhesive with ultraviolet rays to cure the adhesive, in addition to the above-described pressing.

When the reinforcing member 120 is pressed and bonded, for example, it is preferable to perform the pressing and bonding according to the following procedure.

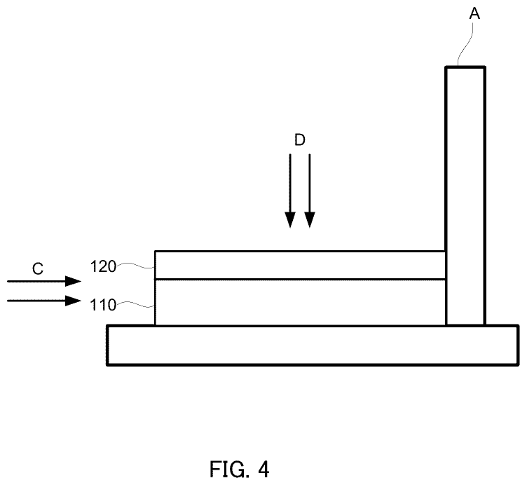

FIG. 4 is a schematic diagram illustrating a state where the reinforcing member 120 is pressed and bonded to the mirror 110. FIG. 4 illustrates each configuration with a different scale than FIG. 1. The mirror 110 to which the reinforcing member 120 has been attached is placed on an L-shaped bonding tool A with the mirror 110 on the bottom side. Thereafter, the mirror 110 and the reinforcing member 120 are fixed by a clamp, and both members are pressed from their side surfaces toward the wall surface A1 of the bonding tool A (in the direction of arrow B in FIG. 4). Next, the reinforcing member 120 is pressed toward the mirror 110 (in the direction indicated by arrow C in FIG. 4) from above.

At this time, it is preferable to chamfer the ridgelines in advance in the adhesive surface 120a between the mirror 110 and the reinforcing member 120. Thus, the overflow of the adhesive during pressing can be more sufficiently suppressed. For the same reason, it is preferable to provide a recess (a recessed portion for preventing the adhesive from contacting) in the wall surface A1 of the bonding tool A.

In the case where the adhesive is an ultraviolet curable adhesive, it is preferable to sandwich the mirror 110 and the reinforcing member 120 by a clip or the like after pressing them as described above, and then put them into an ultraviolet irradiation furnace to cure the adhesive. Thus, the ultraviolet curable adhesive can be efficiently cured.

### 1-3. Image Forming Device and Scanning Optical Device

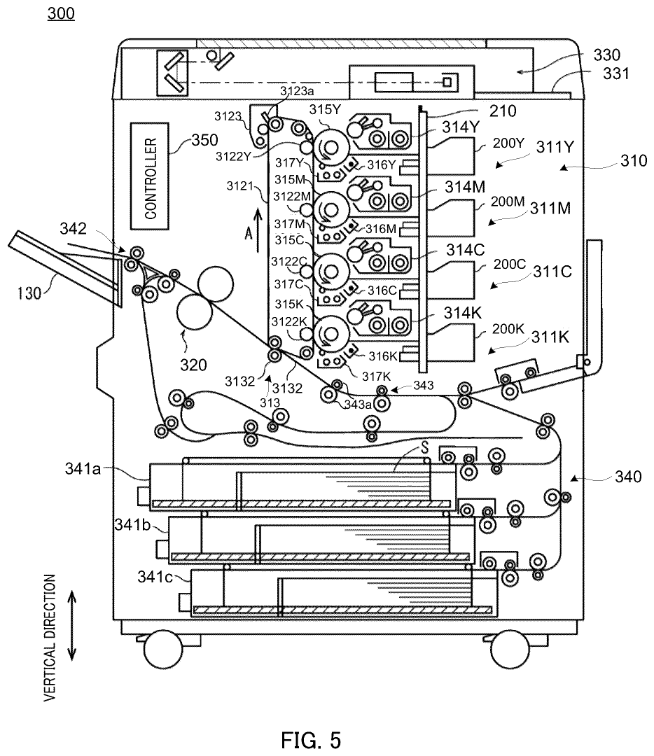

FIG. 5 is a schematic cross-sectional view illustrating an example of a configuration of an image forming device 300 according to the present embodiment. The image forming device 300 has a scanning optical device 200 including the optical mirror 100 described above.

In FIG. 5, the image forming device 300 is a so-called tandem-type color multifunction printer (MFP: Multi-Function Peripheral), but is not limited to this. The image forming device 300 includes an image former 310, a fixing device 320, an image reader 330, and a sheet conveyer 340.

The image former 310 includes image forming units 311Y, 311M, 311C, and 311K that form images with respective toners of colors of Y (yellow), M (magenta), C (cyan), and K (black). They have the same configuration except for the toners stored therein, and therefore the symbol representing the color may be omitted below.

The image former 310 includes the scanning optical device 200, a developing device 314, an electrophotographic photoreceptor (image bearing member) 315, a charging device 316, and a drum cleaning device 317. The image former 310 further includes an intermediate transfer unit 312 and a secondary transfer unit 313. They correspond to a transfer device.

The developing device 314 is a developing device of a two component developing type. The developing device 314 includes, for example, a developer container that stores a two-component developer, a developing roller (magnetic roller) rotatably disposed at an opening portion of the developer container, a partition wall that partitions the inside of the developer container such that the two-component developer can communicate with the partition wall, a conveyance roller for conveying the two-component developer on the opening portion side in the developer container toward the developing roller, and a stirring roller for stirring the two-component developer in the developer container. The developer container stores, for example, two-component developer.

The charging device 316 is, for example, a corona charger. The charging device 316 may be a contact charging device that charges the electrophotographic photoreceptor 315 by bringing a contact charging member such as a charging roller, a charging brush, or a charging blade into contact with the electrophotographic photoreceptor 315. The electrophotographic photoreceptor 315 is a negatively chargeable organic photosensitive member having photoconductivity. The electrophotographic photoreceptor 315 is charged by the charging device 316.

The intermediate transfer unit 312 includes an intermediate transfer belt (intermediate transfer member) 3121, a primary transfer roller 3122 that bring the intermediate transfer belt 3121 into pressure-contact with the electrophotographic photoreceptor 315, and a belt cleaning device 3123. The intermediate transfer belt 3121 is a stretched in a loop shape by a plurality of support rollers. The intermediate transfer belt 3121 travels at a constant speed in the direction of arrow A.

The belt cleaning device 3123 includes an elastic member 3123a. The elastic member 3123a makes contact with the intermediate transfer belt 3121 after the secondary transfer so as to remove the attached substance on the surface of the intermediate transfer belt 3121. The elastic member 3123a is composed of an elastic member, and includes a cleaning blade, a brush, and the like.

The secondary transfer unit 313 includes a secondary transfer roller 3131 pressed against the outer peripheral surface of the intermediate transfer belt 3121, and a secondary transfer belt 3132. A secondary transfer voltage is applied to the secondary transfer roller 313. When the recording medium S is inserted between the intermediate transfer belt 3121 and the secondary transfer roller 127, the toner image is electrostatically transferred from the outer circumferential surface of the intermediate transfer belt 3121 onto the image forming surface of the recording medium S (secondary transfer).

The fixing device 320 is a device in which a pressure roller pressed against a high-temperature fixing roller to form a fixing nip. A fixing belt may be used in place of the fixing roller, and a pressure pad may be used in place of the pressure roller. The recording medium S is inserted through the fixing nip, and thus a toner image is thermally fixed on the recording medium S.

The image reader 330 generates image data by reading a document. The image reader 330 includes an operation panel 331. The operation panel 331 presents information to a user of the image forming device 300 and receives input of an instruction from the user.

The sheet conveyer 340 includes a sheet feeder 341, a sheet ejector 342, and a conveyance path 343. Sheets S identified on the basis of a basis weight, a size, and the like are stored in respective three sheet feed tray units 341a to 341c of the sheet feeder 341 in accordance with preset paper type (a standard sheet or a special sheet). The conveyance path 343 includes a plurality of conveyance roller pairs such as a registration roller pair 343a.

The scanning optical device 200 is a device for forming an electrostatic latent image by emitting light and performing exposure-scanning of the outer circumferential surface of the electrophotographic photoreceptor 315. The light amount of the light emitted from the scanning optical device 200Y, 200M, 200C, and 200K is adjusted according to the image data of each color of YMCK.

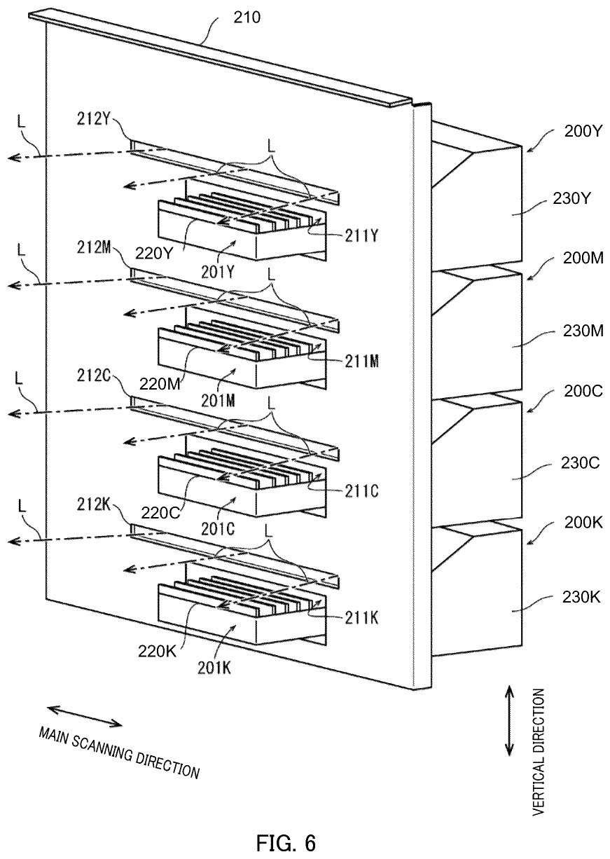

FIG. 6 is an external perspective view illustrating a configuration of the scanning optical device 200. As illustrated in FIG. 6, each scanning optical device 200 is configured with a protrusion 201 protruding toward the electrophotographic photoreceptor 315 from a through hole 211 provided in a partition wall 210.

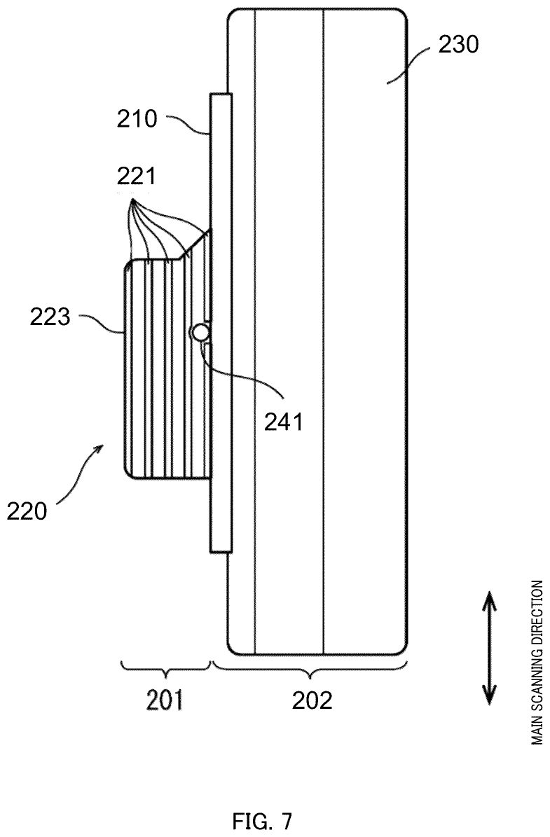

FIG. 7 is a plan view of an appearance of the scanning optical device 200 as viewed from above in the vertical direction. As illustrated in FIG. 7, the portion of the scanning optical device 200 protruding from the partition wall 210 toward the electrophotographic photoreceptor 315 is the protrusion 201, and a portion located opposite to the protrusion 201 with the partition wall 210 therebetween is a storage 202.

An optical deflector 220 is disposed on the protrusion 201 of each scanning optical device 200 and fixed to a housing 230. Each optical deflector 220 includes a polygon mirror 240 (described later). The light beam L emitted from the light source of the scanning optical device 200 is deflected by the polygon mirror 240 of the optical deflector 220, and emitted to the outside of the scanning optical device 200 via the scanning optical system. Then, the light beam L emitted to the outside of the scanning optical device 200 enters the outer peripheral surface of the electrophotographic photoreceptor 315 via a through hole 212 provided in the partition wall 210. Thus, an electrostatic latent image is formed on the outer peripheral surface of the electrophotographic photoreceptor 315. In the present embodiment, a space for transmitting the light beam L is provided between the developing device 314 and the optical deflector 220.

A heat radiation fin 221 is provided on an upper surface 223 of the optical deflector 220. The heat radiation fin 221 is extended along the main scanning direction. A through hole for fixing a rotation shaft (polygon rotors) 241 of the polygon mirror 240 is provided in the upper surface 223 of the optical deflector 220. When the rotation shaft 241 of the polygon mirror 240 is fixed to the through hole, the tip of the rotation shaft is exposed from the upper surface 223. The heat radiation fin 221 is cut out at a portion where the tip of the rotation shaft 241 is exposed.

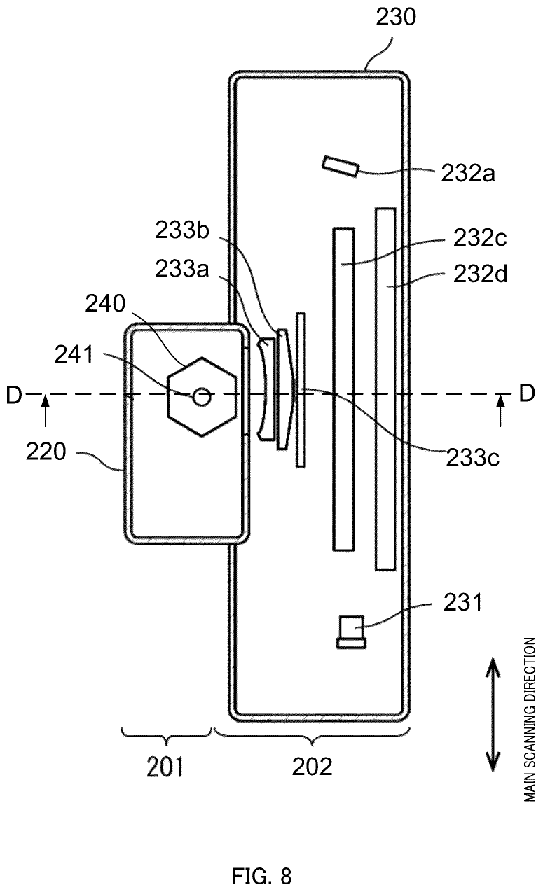

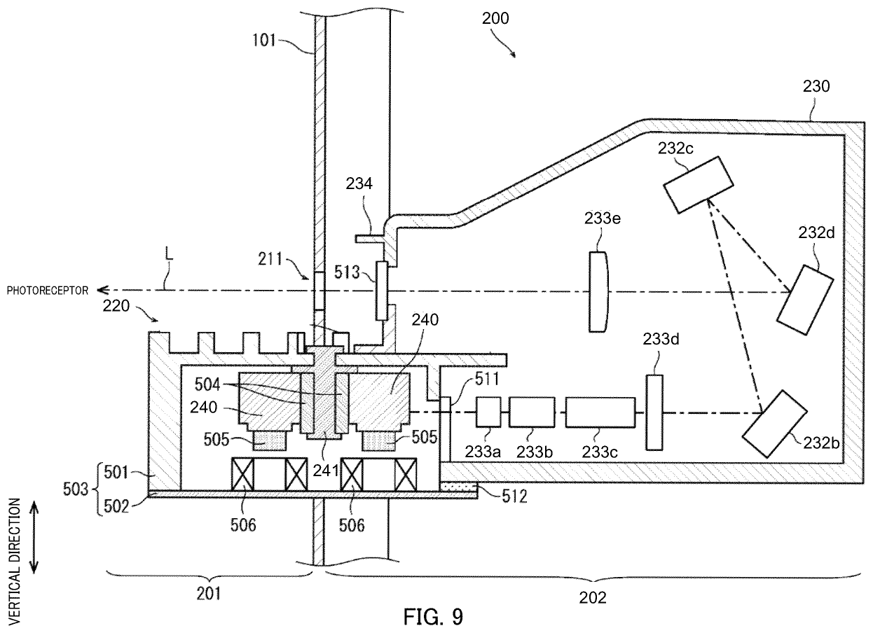

FIG. 8 is a schematic cross-sectional view of the scanning optical device 200 taken along a horizontal plane (on the back side of FIG. 7) below the upper surface 223 of the optical deflector 220 in the vertical direction. FIG. 9 is a schematic cross-sectional view of the scanning optical device 200, taken along line D-D in of FIG. 8. As illustrated in of FIG. 8 and FIG. 9, in the housing 230, a light source 231, mirrors 232a, 232b, 232c, 232d, and fθ lenses 233a, 233b, 233c, 233d, 233e are housed. The light source 231, the mirrors 232a, 232b, 232c, 232d, and the fθ lenses 233a, 233b, 233c, 233d, 233e are held on the internal wall surface of the housing 230.

The type of the light source 231 is not particularly limited, but is preferably a semiconductor laser from the viewpoint of improving image quality.

The mirrors 232a, 232b, 232c, 232d have the function of reflecting the light beam L and causing the light beam L to travel toward a desired position. In the present embodiment, the mirrors 232c and 232d are the above-described optical mirror 100. Note that the optical mirror 100 may be used for the mirrors 232a and 232b.

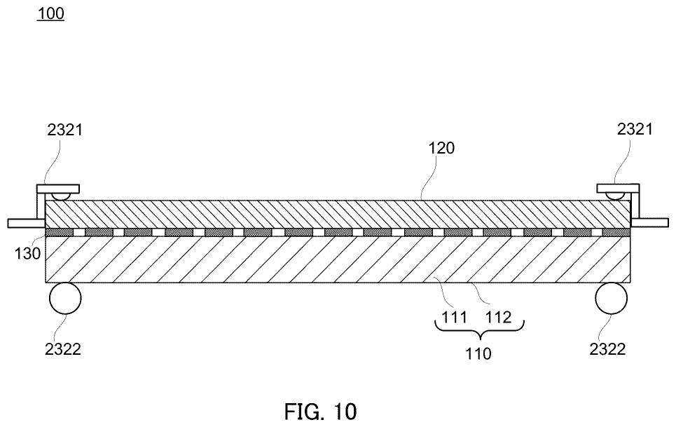

FIG. 10 is a schematic view illustrating an example of an aspect of the optical mirror 100 provided in the scanning optical device 200. As illustrated in FIG. 10, the scanning optical device 200 may further include a pressing member 2321 for pressing the reinforcing member 120 toward the mirror 110. With the pressing member 2321, when the optical mirror 100 is used for a long period of time, deformation of the adhesive layer 130 is less likely to occur, and adhesion displacement between the mirror 110 and the reinforcing member 120 is less likely to occur, thus suppressing fluctuation of the resonance frequency of the optical mirror 100. The pressing member 2321 is, for example, a plate spring. It is preferable that the pressing member 2321 presses both end portions 120b of the reinforcing member 120 in the longitudinal direction.

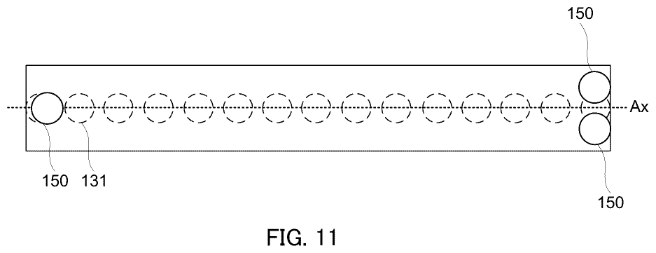

In addition, the scanning optical device 200 may further include a support member 2322 disposed at both end portions in the longitudinal direction of the reflective surface 112 of the mirror 110 and support the mirror 110 from the reflective surface 112 side. FIG. 11 is a plan view of the optical mirror 100 to which support member 2322 is attached, as viewed from the reflective surface 112 side. In FIG. 11, the adhesive layer 130 (in the present embodiment, the plurality of adhesive members 131) on the adhesive surface 120a is indicated by the broken line for the sake of description. As illustrated in FIG. 11, the adhesive layer 130 is disposed such that it at least partially overlaps with the position where the support member 2322 is disposed in plan view as viewed from the reflective surface 112 side. Thus, the rigidity of the optical mirror 100 around the support member 2322 can be increased.

The material of the support member 2322 is not particularly limited, but is, for example, metal such as steel or aluminum. Among these, steel is preferable because of its high rigidity and high availability. In FIG. 11, the spherical member is formed separately from the pressing member, but may be a projection formed integrally with the pressing member.

The support member 2322 needs only to be disposed at both ends of the reflective surface 112 of the mirror 110 in the longitudinal direction. As illustrated in FIG. 11, it is preferable that one of the end portions of the support member 2322 in the longitudinal direction be disposed so as to overlap the central axis Ax and that the other of the end portions of the support member be disposed so as to sandwich the central axis Ax. Thus, the rigidity of the optical mirror 100 can be further increased, and the coincidence between the resonance frequency of the optical mirror 100 and the vibration of the image forming device can be further suppressed.

The fθ/lens 233a is a so-called toroidal lens. The fθ/lenses 233b, 233c and 233e are spherical lenses. The fθ/lens 233d is a cylindrical lens. Note that as these lenses and mirrors, the scanning optical device 200 may adopt a scanning optical system composed of a combination of other lenses and mirrors may be adopted.

The optical deflector 220 includes the polygon mirror 240, a box-shaped container 501, and a polygon motor substrate 502. The type of the polygon motor substrate 502 is not particularly limited, but is, for example, a glass epoxy board. The container 501 and the polygon motor substrate 502 form a casing 503 that houses the polygon mirror 240.

The polygon mirror 240 is a rotary polygon mirror. The rotation shaft 241 of the polygon mirror 240 is fixed to the upper surface 223 of the container 501 using a fixing screw. The polygon mirror 240 is supported by the rotation shaft 241 via an inner cylinder bearing 504, and thus can rotate around the rotation shaft 241. A magnet 505 is attached to the lower end of the polygon mirror 240. Further, a wound coil 506 is disposed on the polygon motor substrate 502 at a position facing the magnet 505. The magnet 505 and the wound coil 506 constitute a polygon motor, and rotationally drive the polygon mirror 240.

The polygon motor substrate 502 further includes a control integrated circuit (IC) and a connector not illustrated in the drawing. The polygon motor substrate 502 is connected to a controller 350 via the connector and receives supply of power and input of a control signal. In response to the control signal, the control IC energizes the wound coil 506 to rotate the polygon mirror 240.

In the present embodiment, the space between the container 501 and the housing 230 is closed by a flat glass 511. A heat insulating member 512 is disposed between the housing 230 and the polygon motor substrate 502. The flat glass 511 prevents foreign substances, such as toner, from moving inside or outside the optical deflector 220 and bonding to optical elements of the scanning optical device 200. Note that the flat glass 511 can transmit the light beam L.

The scanning optical device 200 having such a configuration can expose and scan the outer peripheral surface of the electrophotographic photoreceptor 315 by the following operation.

First, the light beam Lis emitted from the optical source 231, and the light beam L travels into the optical deflector 220 via mirror 232a and the flat glass 511, and then impinges on the polygon mirror 240 that is driven into rotation. Thus, the reflection direction of the light beam L changes according to the rotation angle of the polygon mirror 240. The light beam L reflected by the polygon mirror 240 travels via the fθ lens 233a, 233b, 233c, 233d, the mirrors 232b, 232c, 232d, and the fθ lens 233e in this order, and then emitted to the outside of the scanning optical device 200 through an emission part 234. The light beam L emitted to the outside of the scanning optical device 200 passes above the upper surface 223 of the optical deflector 220 and enters the outer peripheral surface of the electrophotographic photoreceptor 315. The light beam L is deflected in the main scanning direction while the light amount is modulated in accordance with image data. Thus, an electrostatic latent image is formed.

Note that in the present embodiment, the flat glass plate 513 is also arranged in the emission part 234. As the flat plate glass 513, a flat plate glass similar to the flat plate glass 511 can be used.

Next, an operation of the image forming device 300 illustrated in FIG. 5 will be described. The document is read by the image reader 330 into the form of input image data. The input image data is subjected to predetermined image processing in an image processor (not illustrated) and is sent to the scanning optical device 200 via the controller 350.

The electrophotographic photoreceptor 315 rotates at a constant circumferential speed. The charging device 316 uniformly and negatively charges the surface of the electrophotographic photoreceptor 315. In the scanning optical device 200, the polygon mirror of the polygon motor rotates at a high speed, the laser light corresponding to the input image data of each color component develops along the axial direction of the electrophotographic photoreceptor 315, and the outer peripheral surface of the electrophotographic photoreceptor 315 is irradiated with the laser light along the axial direction. Thus, an electrostatic latent image is formed on the surface of the electrophotographic photoreceptor 315.

In the developing device 314, the toner base particles are charged by stirring and conveying the two-component developer in the developer container, and the two-component developer is conveyed to the developing roller to form a magnetic brush on the surface of the developing roller. The charged toner base particles are electrostatically attached to a portion of the electrostatic latent image on the electrophotographic photoreceptor 315 from the magnetic brush. Thus, the electrostatic latent image on the surface of the electrophotographic photoreceptor 315 is visualized, and a toner image corresponding to the electrostatic latent image is formed on the surface of the electrophotographic photoreceptor 315. Note that the term “toner image” refers to a state in which toner is aggregated to form an image.

The toner image on the surface of the electrophotographic photoreceptor 315 is transferred to the intermediate transfer belt 3121 by the intermediate transfer unit 312. The transfer residual toner remaining on the surface of the electrophotographic photoreceptor 315 after transfer is removed by the drum cleaning device 317 including a drum cleaning blade that comes in sliding contact with the surface of the electrophotographic photoreceptor 315.

The intermediate transfer belt 3121 is pressed against the electrophotographic photoreceptor 315 by the primary transfer roller 3122, and thus a primary transfer nip is formed by the electrophotographic photoreceptor 315 and the intermediate transfer belt 3121 for each electrophotographic photoreceptor. At the primary transfer nip, the toner images in respective colors are sequentially transferred onto the intermediate transfer belt 3121 in a superimposed manner.

On the other hand, the secondary transfer roller 3131 is pressed against the intermediate transfer belt 3121 and the secondary transfer belt 3132. Thus, a secondary transfer nip is formed by the intermediate transfer belt 3121 and the secondary transfer belt 3132. The sheet S passes through the secondary transfer nip. The sheet S is conveyed to the secondary transfer nip by the sheet conveyer 340. The correction of the inclination of the sheet S and the adjustment of the conveyance timing are performed by a registration roller unit in which the registration roller pair 343a is arranged.

When the sheet S is conveyed to the secondary transfer nip, a transfer bias is applied to the secondary transfer roller 3131. By the application of the transfer bias, the toner image carried on the intermediate transfer belt 3121 is transferred to the sheet S (a step of attaching the electrostatic charge image developing toner to the recording medium). The sheet S on which the toner image has been transferred is conveyed toward the fixing device 320 by the secondary transfer belt 3132.

Adhered substances such as transfer residual toner remaining on the surface of the intermediate transfer belt 3121 after the secondary transfer are removed by the belt cleaning device 3126 having a cleaning blade that is brought into sliding contact with the surface of the intermediate transfer belt 3121. At this time, since the above-described intermediate transfer member is used as the intermediate transfer belt, the dynamic frictional force can be reduced with time.

The fixing device 320 sandwiches the fixing belt between the rotating fixing roller and pressure roller to form a fixing nip, and heats and pressurizes the conveyed sheet S in the fixing nip part. Thus, the toner image is fixed onto the sheet S (a process of fixing the electrostatic charge image developing toner onto the recording medium). The sheet S carrying a fixed toner image is discharged to the outside of the apparatus by the sheet ejector 342 having sheet ejection roller 342a.

### 2 Second Embodiment

### 2-1. Optical Mirror

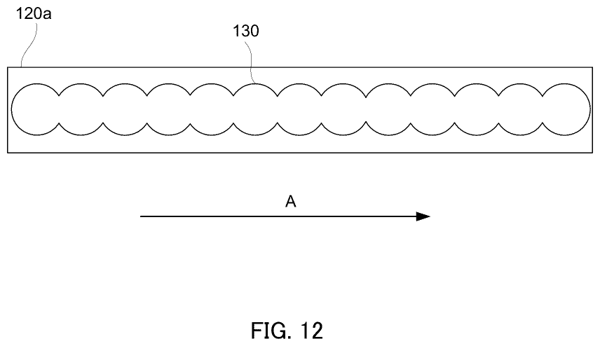

FIG. 12 is a plan view illustrating the adhesive surface 120a between the mirror 110 and the reinforcing member 120 and the adhesive layer 130 of an optical mirror 400 according to the second embodiment. As illustrated in FIG. 12, the optical mirror in the second embodiment is different from the optical mirror 100 in the first embodiment in that the adhesive layer 130 is an adhesive layer formed of the plurality of adhesive members 131 partially connected to each other.

Since the adhesive layer 130 is an adhesive layer in which the plurality of adhesive members 131 are partially connected, the resonance frequencies of the and tertiary bending vibrations and the resonance frequencies of the torsional vibrations of the optical mirror 400 can be made close to values thereof when the adhesive layer 130 covers the entire surface of the adhesive surface 120a. When the adhesive layer 130 covers the entire adhesive surface 120a, the resonance of the tertiary bending vibration and the resonance of the torsional vibration are unlikely to occur in the image forming device. Therefore, the optical mirror 400 according to the present embodiment can reduce the burden on the operator due to overflow of an adhesive during production while suppressing resonance of the tertiary bending vibration and resonance of the torsional vibration.

In the case where the reinforcing member is transparent, whether the adhesive layer 130 is an adhesive layer in which the plurality of adhesive members 131 are partially connected can be visually confirmed by observing the shape of the adhesive layer. In the case where the reinforcing member is not transparent and cannot be visually determined, it can be confirmed by peeling the adhesion and visually observing the shape of the adhesive layer.

The total of the maximum length of the adhesive layer 130 in the longitudinal direction of the adhesive surface 120a is 40% or more, preferably 60% or more, of the dimension of the adhesive surface 120a in the longitudinal direction (the direction of arrow A in FIG.; 12). The upper limit of the total of the length is, for example, 100% of the longitudinal length of the adhesive surface 120a.

The ratio of the area covered by the adhesive layer 130 to the area of the adhesive surface 120a is preferably 30% or more and less than 100%, more preferably 50% or more and less than 100%.

### 2-2. Manufacturing Method for Optical Mirror

The optical mirror 400 can be manufactured by adjusting the application amount and the application interval of the adhesive in the step of applying the adhesive in the manufacturing method for the optical mirror according to the first embodiment.

The application interval of the adhesive is preferably a length equal to or greater than 0.94 times the width of the substrate. Thus, when bonding the mirror 110 and the reinforcing member 120 together, the plurality of adhesive members 131 tend to be partially connected. The lower limit value of the coating interval is, for example, 0 mm.

### EXAMPLE

In the following, the present invention will be described with reference to an example. The scope of the present invention should not be construed as being limited to the examples.

### Resonance Frequency of Primary Bending Vibration

For the optical mirrors 1 to 8 satisfying the conditions in Table 1, the respective resonance frequencies of the primary bending vibration were obtained using simulation software (manufactured by ANSYS, ANSYS2023R1). In the optical mirrors 1 to 8, the adhesive layer is formed with a plurality of adhesive members composed of cured adhesive disposed at intervals, and the intervals between the plurality of adhesive members are equal intervals. The cross section of the adhesive member parallel to the adhesive surface is a circle with a diameter of φ14 mm.

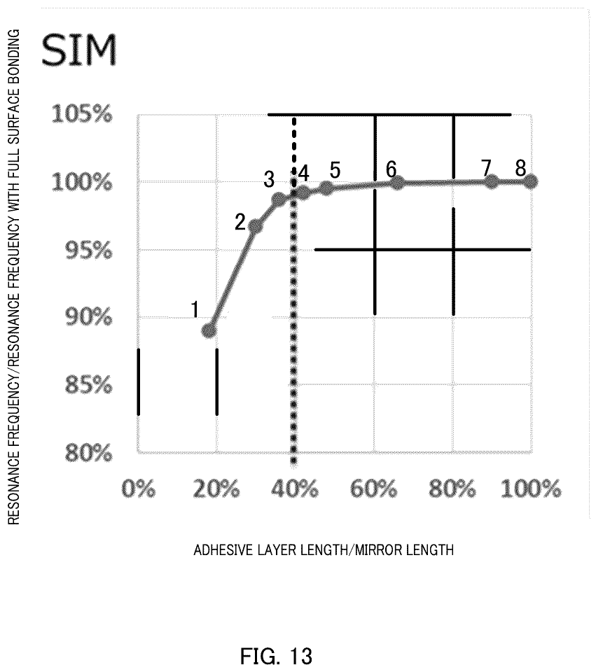

For comparison, the resonance frequency of an optical mirror in which an adhesive was applied to the entire surface of the adhesive surface between the mirror and the reinforcing member was obtained in the same manner. With respect to the determined resonance frequency in this case defined as 100%, the ratios of the resonance frequencies of the optical mirrors 1 to 8 were determined, and FIG. 13 illustrates the relationships between the ratios and the lengths of the adhesive layers.

Note that in the above-described simulation, the mirror and the reinforcing member described below were used, and the adhesive and the support member were expressed by setting of simulation software. Furthermore, in the simulation, as illustrated in FIG. 11, the support members were disposed at both ends in the longitudinal direction of the mirror, one on one end side and two on the other end side. Mirror (thickness: 5.5 mm, length in longitudinal direction: 233 mm, breadth: 15 mm, aspect ratio: 15.5). Reinforcing member (made of glass, thicknesses 3 mm, length in longitudinal direction: 233 mm, breadth: 15 mm, aspect ratio: 15.5).

The adhesive was expressed with the connection setting between the substrate and the reinforcing member at the adhesive member set as a bond (setting in which the surfaces do not deviate from each other). This setting was made because, at the time of applying the adhesive, the adhesive was pressed until the substrate and the reinforcing member make contact with each other such that it becomes a thin layer with a thinnest portion of about 1 μm, and as such deformation (shear deformation) of the adhesive is negligible. The support member is expressed in such a manner that on one end side (one point holding side), the displacement of the support member is fixed at the contact point between the support member and the substrate, and that on the other end side (two point holding side), the rotation of the support member in the in-plane direction and the displacement in the thickness direction/short direction are fixed at the contact point between the support member and the substrate.

In Table 1, the “length of the adhesive layer in the longitudinal direction” means the total length of the adhesive member in the longitudinal direction on the central axis extending in the longitudinal direction of the adhesive surface between the mirror and the reinforcing member.

TABLE 1

| | Length of adhesive layer in |
|---|---|
| Optical | longitudinal direction/Length |
| mirror | of mirror body in longitudinal |
| No | direction [%] |
| 1 | 18.0 |
| 2 | 30.0 |
| 3 | 36.1 |
| 4 | 42.1 |
| 5 | 48.1 |
| 6 | 66.1 |
| 7 | 90.1 |
| 8 | 100 |

As illustrated in FIG. 13, when the length of the adhesive layer was 40% or more of the length of the mirror, the variation in the resonance frequency due to the variation in the length of the adhesive layer less occurred. Furthermore, it has been found that when the length of the adhesive layer is 40% or more of the length of the mirror, the resonance frequency of the optical mirror approaches the resonance frequency when the adhesive layer covers the entire surface of the adhesive surface between the mirror and the reinforcing member. Note that the numbers 1 to 8 given in the graph of FIG. 13 correspond to the optical mirrors 1 to 8, respectively.

### Resonance Frequency of Secondary Bending Vibration

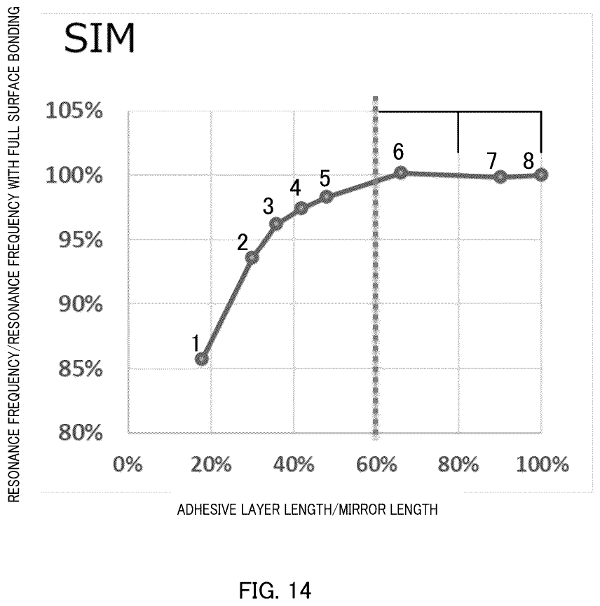

For the optical mirrors 1 to 8, the resonance frequency of the secondary bending vibration was obtained using the simulation software. For comparison, the resonance frequency of the secondary bending vibration was obtained in the same manner for an optical mirror in which an adhesive was applied to the entire adhesive surface between the mirror and the reinforcing member. The ratios of the resonance frequencies of the optical mirrors 1 to 8 when the resonance frequencies obtained here were defined as 100% were obtained, and the relations between the ratios and the lengths of the adhesive layers were illustrated in FIG. 14.

As illustrated in FIG. 14, when the length of the adhesive layer was 60% or more of the length of the mirror, the variation in the resonance frequency of the secondary bending vibration due to the variation in the length of the adhesive layer less occurred. In addition, it has been found that when the length of the adhesive layer is 60% or more of the length of the mirror, the resonance frequency of the secondary bending vibration of the optical mirror approaches the resonance frequency of the secondary bending vibration when the adhesive layer covers the entire adhesive surface between the mirror and the reinforcing member. Note that the numbers 1 to 8 given in the graph of FIG. 14 correspond to the optical mirrors 1 to 8, respectively.

### Resonance Frequencies of Tertiary Bending Vibration and Torsional Vibration

The resonance frequency of the tertiary bending vibration and the resonance frequency of the torsional vibration of the optical mirror 9 having an adhesive layer formed by partially connecting a plurality of adhesive layers were obtained using the simulation software. Note that the conditions for the mirror, the reinforcing members, the adhesive, and the support members are similar to those for the optical mirrors 1 to 8. The length of the adhesive layer of the optical mirror 9 in the longitudinal direction is 8087% to 100% of the length of the mirror in the longitudinal direction.

For comparison, the resonance frequency of the tertiary bending vibration and the resonance frequency of the torsional vibration were similarly obtained for an optical mirror in which an adhesive was applied to the entire surface of the adhesive surface between the mirror body (body part) and the reinforcing member.

The ratio of the resonance frequency of the tertiary bending vibration of the optical mirror 9 to the resonance frequency of the tertiary bending vibration of the optical mirror in which the adhesive was applied to the entire surface of the adhesive surface to the reinforcing member was 99.97%. Further, the ratio of the resonance frequency of the torsional vibration of the optical mirror 9 to the resonance frequency of the torsional vibration of the optical mirror in which the adhesive was applied to the entire surface of the adhesive surface with the reinforcing member was 99.67%.

### Influence of Interval of Adhesive Member

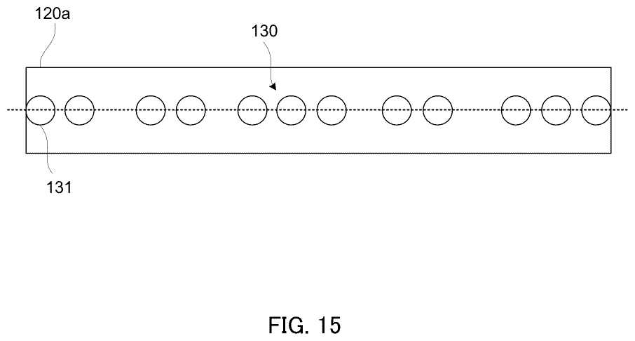

For the optical mirror 10 and the optical mirror 11, the resonance frequency of the primary bending vibration was obtained by using the simulation software. In the optical mirror 10, a plurality of adhesive members formed by curing the adhesive are arranged at equal intervals (see FIG. 2). In the optical mirror 11, a plurality of the above-described adhesive members are arranged at uneven intervals (see FIG. 15). In both the optical mirror 10 and the optical mirror 11, the lengths of the adhesive layers in the longitudinal direction are 66% of the lengths of the mirrors in the longitudinal direction. The ratio of the resonance frequency of the optical mirror 10 to the resonance frequency of the optical mirror in which the adhesive was applied to the entire surface of the adhesive surface to the reinforcing member was 99.9%. On the other hand, the ratio of the optical mirror 11 was 99.7%.

### INDUSTRIAL APPLICABILITY

The optical mirror according to the present invention can suppress resonance in the image forming device. Therefore, the present invention is useful in the field of image formation.

Although embodiments of the present invention have been described and illustrated in detail, the disclosed embodiments are made for purposes of illustration and example only and not limitation. The scope of the present invention should be interpreted by terms of the appended claims.

What is claimed is:

1. An optical mirror with an elongated shape, comprising:
a mirror including a substrate and a reflective surface formed on one end surface in a thickness direction of the substrate;
a reinforcing member with an elongated shape bonded to a surface of the mirror opposite to the reflective surface;
an adhesive layer disposed between the mirror and the reinforcing member,
wherein the adhesive layer partially covers an adhesive surface between the mirror and the reinforcing member, and
wherein in a longitudinal direction of the adhesive surface, a sum of a maximum length of the adhesive layer in the longitudinal direction is 40% or more of a length of the adhesive surface in the longitudinal direction.

2. The optical mirror according to claim 1, wherein on a central axis extending in the longitudinal direction of the adhesive surface, a sum of a length of the adhesive layer in the longitudinal direction is 60% or more of a length of the mirror in the longitudinal direction.

3. The optical mirror according to claim 1, wherein the adhesive layer includes a plurality of adhesive members.

4. The optical mirror according to claim 3, wherein the plurality of adhesive members are arranged at equal intervals.

5. The optical mirror according to claim 1, wherein in the adhesive layer, a plurality of adhesive members are partially connected.

6. The optical mirror according to claim 1, wherein the reinforcing member is made of glass.

7. The optical mirror according to claim 6, wherein the reinforcing member has an unpolished surface, and has a thickness smaller than a thickness of the mirror.

8. The optical mirror according to claim 6, wherein the substrate of the mirror and the reinforcing member are made of a same type of material.

9. The optical mirror according to claim 1, wherein the adhesive layer is an adhesive layer formed by curing an ultraviolet curable adhesive.

10. The optical mirror according to claim 1, wherein the mirror and the reinforcing member have the same lengths and widths in the longitudinal direction.

11. A scanning optical device comprising the optical mirror according to claim 1.

12. The scanning optical device according to claim 11, further comprising a pressing member for pressing the reinforcing member of the optical mirror toward the mirror.

13. The scanning optical device according to claim 11, further comprising a support member that is disposed at both ends in the longitudinal direction of the reflective surface of the optical mirror, and supports the mirror from the reflective surface side,
wherein the adhesive layer of the optical mirror is disposed such that at least a part of the adhesive layer overlaps a position where the support member is disposed in plan view as viewed from the reflective surface side.

14. An image forming device comprising the scanning optical device according to claim 11.

15. A manufacturing method for an optical mirror, comprising:
applying an adhesive to a plurality of places at intervals on a surface of a mirror including a reflective surface, the surface being opposite to the reflective surface; and
attaching a reinforcing member to the surface of the mirror to which the adhesive is applied; and
bonding the mirror and the reinforcing member.

16. The manufacturing method for the optical mirror according to claim 15, wherein in the applying, the adhesive is applied through dot application.

17. The manufacturing method for the optical mirror according to claim 15,
wherein the adhesive is an ultraviolet curable adhesive, and
wherein in the bonding, the mirror and the reinforcing member are placed in an ultraviolet irradiation furnace and the adhesive is cured, to bond the mirror and the reinforcing member.
